(19) United States
(12) Patent Application Publication
(10) Pub. No.: US 2025/0277918 A1
(43) Pub. Date: Sep. 4, 2025

(54) 3D ANGLE-DOMAIN SEISMIC RESIDUAL STATICS

(71) Applicant: SAUDI ARABIAN OIL COMPANY, Dhahran (SA)

(72) Inventors: Daniele Colombo, Dhahran (SA); Ernesto Sandoval-Curiel, Dhahran (SA)

(73) Assignee: SAUDI ARABIAN OIL COMPANY, Dhahran (SA)

(21) Appl. No.: 18/592,347

(22) Filed: Feb. 29, 2024

(51) Int. Cl. G01V 1/36; E21B 44/00; G01V 1/30

(52) U.S. Cl. CPC G01V 1/362; E21B 44/00; G01V 1/301; G01V 1/303; G01V 2210/53

(57) ABSTRACT

Methods and systems for correcting a seismic dataset are disclosed. The methods may include receiving a seismic dataset comprising a plurality of traces and sorting the plurality of traces into a plurality of bins, wherein each bin comprises a range of seismic source-seismic receiver midpoint locations, range of offsets, and range of azimuths. The methods may also include, for each of the plurality of bins determining a pilot trace based on a plurality of sorted traces in the bin, selecting a pilot refraction window and a pilot reflection window from the pilot trace; selecting for each of the plurality of sorted traces, a refraction window and a reflection window from the sorted trace, determining a correction value based on the refraction window, the pilot refraction window, the reflection window and the pilot reflection window; and determining a corrected trace by applying the correction value to the trace.

### BACKGROUND

In the oil and gas industry, seismic surveys are conducted over subsurface regions of interest during the search for, and characterization of, hydrocarbon reservoirs. In seismic surveys, a seismic source generates seismic waves that propagate through the subterranean region of interest and are detected by seismic receivers. The seismic receivers detect and store a time-series of samples of earth motion caused by the seismic waves. The collection of a time-series of samples recorded at many receiver locations generated by a seismic source at many source locations constitutes a seismic dataset.

To determine the earth structure, including the presence of hydrocarbons, the seismic dataset may be processed. Processing a seismic dataset includes a sequence of steps designed to correct for a number of issues, such as near-surface effects, noise, irregularities in the seismic survey geometry, etc. In another step in processing a seismic dataset, a seismic velocity model may be determined representing the speed at which seismic waves propagate at various points within the subsurface. The seismic dataset and the seismic velocity model may be combined using a process called “migration” to form a seismic image of the subsurface. Typically, such a seismic image displays points of high and low seismic reflection amplitude, on a color scale or grayscale, on a dense, two-dimensional (“2D”) or three-dimensional (“3D”) grid of points representing the subsurface below the seismic survey area. Such a seismic image may then be interpreted, together with other information, to determine geological structures that may contain hydrocarbons extractable with a wellbore drilled from the surface.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method for correcting a seismic dataset pertaining to a subterranean region. The method includes receiving a seismic dataset comprising a plurality of traces, where each of the plurality of traces represents a time-series of ground motion caused by an activation of a seismic source at a seismic source location and recorded by a seismic receiver at a seismic receiver location, and sorting the plurality of traces into a plurality of bins, where each bin comprises a range of midpoint locations, a range of seismic source-seismic receiver offsets, and a range of seismic source-seismic receiver azimuths. The method also includes, for each of the plurality of bins, determining a pilot trace based on a plurality of sorted traces in the bin, selecting a pilot refraction window from the pilot trace, and selecting a pilot reflection window from the pilot trace. The method further includes, for each of the plurality of sorted traces, selecting a refraction window from the sorted trace, selecting a reflection window from the sorted trace, determining a correction value based on the refraction window, the pilot refraction window, reflection window and the pilot reflection window, and determining a corrected trace by applying the correction value to the trace.

In general, in one aspect, embodiments relate to a system for correcting a seismic dataset pertaining to a subterranean region. The system for correcting a seismic dataset includes a seismic acquisition system and a seismic processing system. The seismic acquisition system is configured to acquire a seismic dataset pertaining to the subterranean region. The seismic processing system is configured to receive the seismic dataset from the seismic acquisition system, where the seismic dataset contains a plurality of traces, where each of the plurality of traces represents a time-series of ground motion caused by an activation of a seismic source at a seismic source location and recorded by a seismic receiver at a seismic receiver location, and sort the plurality of traces into a plurality of bins, wherein each bin comprises a range of midpoint locations, a range of seismic source-seismic receiver offsets, and a range of seismic source-seismic receiver azimuths. The seismic processing system is further configured to, for each of the plurality of bins, determine a pilot trace based on a plurality of sorted traces in the bin, select a pilot refraction window from the pilot trace, and select a pilot reflection window from the pilot trace. The seismic processing system is still further configured to, for each of the plurality of sorted traces, select a refraction window from the sorted trace, select a reflection window from the sorted trace, determine a correction value based on the refraction window, the pilot refraction window, reflection window and the pilot reflection window; and determine a corrected trace by applying the correction value to the trace.

It is intended that the subject matter of any of the embodiments described herein may be combined with other embodiments described separately, except where otherwise contradictory. Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The advantages and features of the present invention will become better understood with reference to the following more detailed description taken in conjunction with the accompanying drawings in which:

FIG. 1 shows a flowchart in accordance with one or more embodiments;

FIG. 2 depicts a seismic acquisition system in accordance with one or more embodiments;

FIG. 3 depicts an illustrative earth model;

FIG. 4 depicts an illustrative cross-section through an earth model;

FIGS. 5A and 5B depict seismic gathers in accordance with one or more embodiments;

FIGS. 6A and 6B illustrates seismic gather geometries in accordance with one or more embodiments;

FIGS. 7A and 7B illustrates seismic gather geometries in accordance with one or more embodiments;

FIG. 8 shows a flowchart in accordance with one or more embodiments;

FIG. 9 shows a flowchart in accordance with one or more embodiments;

FIGS. 10A and 10B depict seismic gathers in accordance with one or more embodiments;

FIGS. 11A-11F depicts a residual statics in accordance with one or more embodiments;

FIG. 12 depicts a drilling system in accordance with one or more embodiments;

FIG. 13 depicts a computer system in accordance with one or more embodiments; and

FIG. 14 shows a flowchart in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

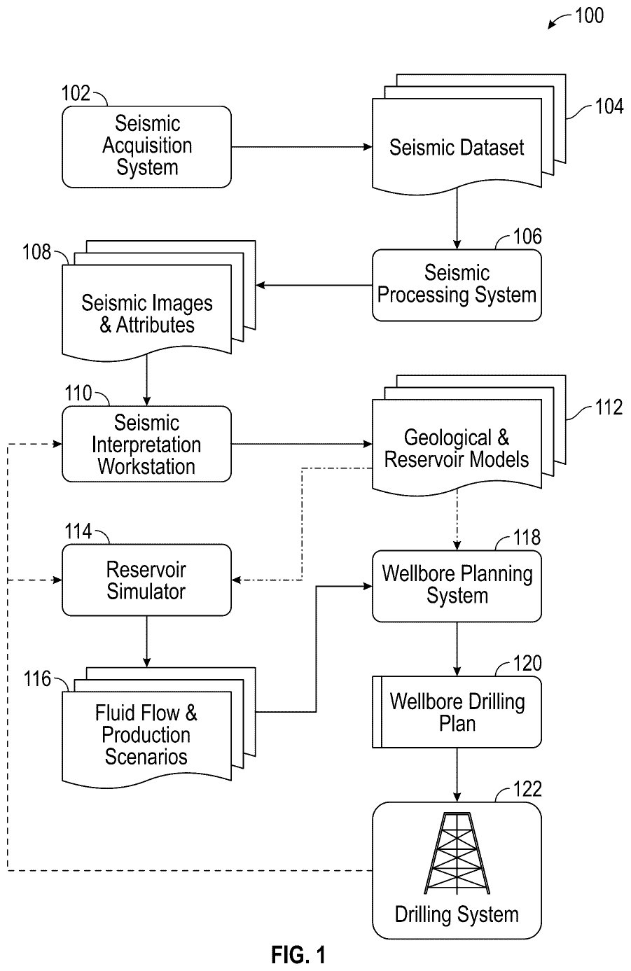

In the following description of FIGS. 1-13, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a static correction” includes reference to one or more of such static corrections.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Seismic datasets acquired during a land seismic survey typically include tens or hundreds of billions of traces. Each trace corresponds to a time-series of earth motion measurements recorded by a seismic receiver positioned on or near the surface of the earth. Each seismic receiver records ground motion resulting from the arrival of seismic waves (sometimes called “seismic signals”) that have propagated through the earth after emission from a seismic source that is also typically positioned on the surface of the earth. A typical seismic survey may involve activating one or more seismic sources at tens of thousands of different seismic source locations.

While the arrival time and amplitude of seismic signals may be affected by the characteristics, e.g., the seismic propagation velocity and density, of the whole of the subterranean region through which the seismic signals propagate, heterogeneity in the shallow subsurface is particularly problematic as the heterogeneity only affects the seismic data recorded by the receiver, or receivers, immediately above the heterogeneity. Similar considerations apply to seismic sources and the shallow heterogeneities immediately below the locations at which the seismic sources are activated. In addition to subsurface heterogeneities, topography of the land surface can produce similar effects, with receivers located on elevated features detecting (upward propagating) seismic waves later than receivers located on lower-lying regions. Traditionally, these local perturbations to the arrival time and amplitudes of seismic signals are termed “static perturbations” or just “statics” and procedures for correcting or compensating for them are called “statics correction”.

Disclosed herein are processes for statics corrections that may be applied automatically based on sorting the seismic datasets into groups of traces or “bins” that share a common midpoint, a common offset and a common offset azimuth. These disclosed processes form a demonstrable improvement over conventional methods in both accuracy and ease of application.

FIG. 1 depicts a flowchart (100) in accordance with one or more embodiments. FIG. 1 illustrates the steps of acquiring remote sensing data, processing the remote sensing data, forming a geological model, optionally simulating the flow of fluids, including hydrocarbons, though the geological model, the planning of wellbores including their surface position, trajectories, and targets, and the drilling of those wellbores. Although the steps in flowchart (100) are shown in sequential order, it will be apparent to one of ordinary skill in the art that some steps may be conducted in parallel, or in a different order than shown, or may be omitted without departing form the scope of the invention.

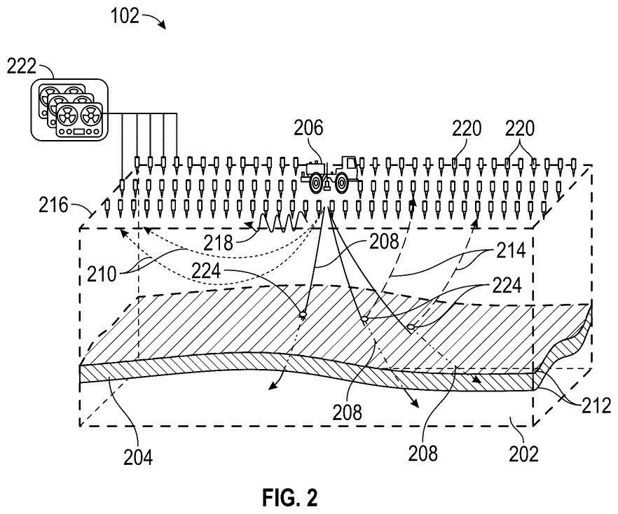

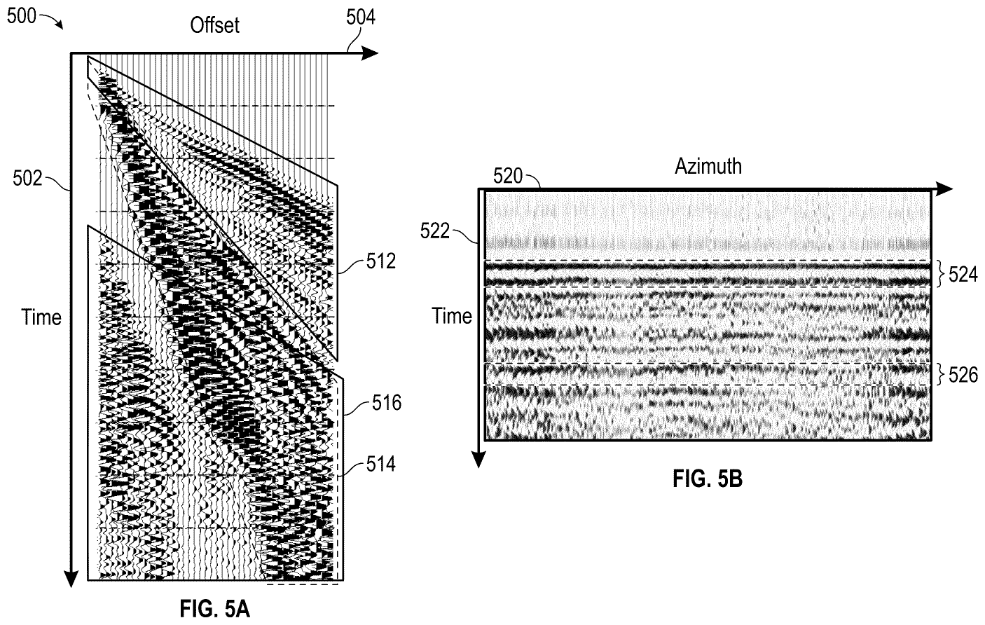

For example, flowchart (100) may begin with the use of a seismic acquisition system (102) to acquire a seismic dataset (104) over a subterranean region of interest. The seismic acquisition system (102) will be described in more detail in the context of FIG. 2 and an example of a seismic dataset is shown in FIGS. 5A and 5B. Other remote sensing datasets may also be collected at this stage to characterize the subterranean region of interest. For example, resistivity, transient electromagnetic, and/or gravitation surveys may be collected.

The seismic dataset contains seismic recordings that are influenced by the geological structure of the subterranean region. However, seismic datasets (104) also contain a wide variety of noise and distortion and does not in its unprocessed “raw” form display significant useful information about the subterranean region. Consequently, seismic datasets (104) are typically processed to remove or attenuate noise and to correctly locate geological boundaries that reflect seismic waves (“seismic reflectors”) in two-dimensional (“2D”) or three-dimensional (“3D”) space within the subterranean region.

To determine earth structure, including the presence of hydrocarbons, the seismic data set must be processed. Processing a seismic dataset includes a sequence of steps designed to correct for near-surface effects, attenuate noise, compensate for irregularities in the seismic survey geometry, calculate a seismic velocity model, image reflectors in the subterranean and calculate a plurality of seismic attributes to characterize the subterranean region of interest to determine a drilling target. Each of these steps may be accompanied by one or more quality control steps. Although shallow, i.e., near-surface, heterogeneities in the seismic velocity and density could in principle be considered as part of the seismic velocity model and density model, respectively, in practice, because their effects are localized to only the receivers immediately above them, these effects are typically treated as noise to be corrected for.

It will be appreciated by one of ordinary skill in the art that seismic datasets (104) are extremely large, typically occupying hundreds of Terabytes or more than a Petabyte in size, (corresponding to between 10 trillion (10¹³) and 100 trillion (10¹⁴) data samples) and cannot be manipulated or “processed” without the assistance of a purpose configured seismic processing system (106).

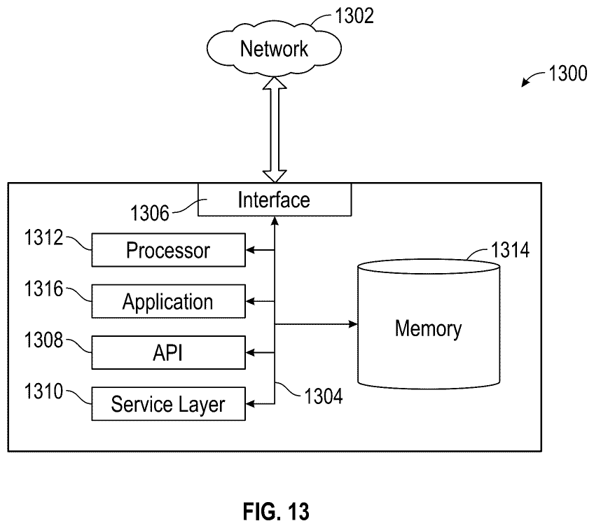

A seismic processing system (106) may be composed of a computer system, such as the computer system shown in FIG. 13. However, a seismic processing system will typically be configured with appropriate seismic processing software and augmented with a number of purpose specific elements, such as high-capacity tape drives or hard drives connected through high-speed buses to computer processing units (“CPUs”). Further the CPUs of a seismic processing system will typically be connected to a plurality of graphical processing units (“GPUs”) that perform many of the computationally intensive operations on the seismic dataset (104), banks of high-speed tape, or hard-drive, readers to read the data from storage, high-speed tape or hard-drive writers to output final or intermediate results, and high-speed communication buses to connect these elements.

The result of processing a seismic dataset (104) with a seismic processing system (106) is a seismic image (108). The seismic image may be represented as a 2D or 3D image of the points within the subsurface that generate a distinctive seismic response. For example, the seismic image (108) may display the points at which seismic energy is reflected, or scattered, within the subsurface. Other seismic characteristics or “attributes” of the subsurface may also be displayed as a seismic image (108). For example, the strength of conversion of energy from one type of seismic wave to another, the strength of absorption of seismic energy, or the velocity of seismic propagation may be displayed as a function of subsurface position as a seismic image (108). The examples of seismic attributes given above are purely illustrative; a person of ordinary skill in the art will appreciate that any of dozens of other attributes may be displayed as a seismic image (108) and the examples described should not be interpreted as limiting the scope of the invention in any way.

The seismic image (108) is an image, typically composed of pixels of varying intensity or amplitude, and is not itself a model of the geological structure of the subterranean region to which it pertains. To determine the geological structure corresponding to, or that produced, the seismic image (108) typically requires that the seismic image (108) is “interpreted” using a seismic interpretation workstation (110).

A seismic interpretation system (110) is primarily used by geoscientists, seismic interpreters, and exploration teams in the oil and gas industry for analyzing seismic data to understand subsurface geological structures. Seismic interpreters use the workstation to visualize seismic data, including 2D and 3D seismic volumes, cross-sections, time slices, and attribute maps. These visualizations provide insights into subsurface structures, faults, and potential hydrocarbon reservoirs. Additional data may be used within the seismic interpretation workstation (110) to facilitate the interpretation of the seismic dataset. Such additional data may include well logs acquired from previously drilled wells and acquired either while-drilling or via wireline conveyed well logging tools after drilling. Such data may also include non-seismic remote sensing datasets such as resistivity, transient electromagnetic, and/or gravitational surveys.

Interpreters may pick and interpret key geological horizons within seismic data to identify stratigraphic layers, boundaries, and structural features. Horizon interpretation tools and workflows allow for the accurate extraction of geological information from seismic volumes. For example, a seismic interpretation system (110) enables interpreters to identify and interpret subsurface faults that may impact hydrocarbon reservoirs. Fault interpretation tools and visualization techniques help in understanding fault geometry, connectivity, and spatial relationships. Seismic attributes, such as amplitude, frequency, and gradient, provide additional information about subsurface properties and can be analyzed using various algorithms and statistical methods. Attribute analysis tools in the workstation aid in defining reservoir characteristics, identifying anomalies, and highlighting potential hydrocarbon traps.

Interpreters may use the seismic interpretation system (110) to build 3D geological models by integrating seismic data with well-log data, geological knowledge, and other geophysical information. These models help in estimating reservoir properties, optimizing well locations, and predicting hydrocarbon distributions. Interpreters may analyze and characterize hydrocarbon reservoirs by integrating different data sources, including seismic data, well logs, production data, and seismic inversion results. Workstations provide tools for reservoir property estimation, quantitative analysis, and reservoir performance evaluation.

The seismic interpretation system (110) may facilitate prospect generation and evaluation, where interpreters identify and assess areas with high hydrocarbon exploration potential. They can perform detailed geological and geophysical analysis, identify drilling targets, and quantify the risk and uncertainty associated with potential prospects. Finally, workstations enable interpreters to collaborate with team members, share interpretation results, and communicate findings effectively. Interpretation software allows for the creation of reports, annotated images, and presentations to communicate geological interpretations to stakeholders.

The seismic interpretation system (110) provides valuable tools for geoscientists involved in exploration and production activities, helping them make informed decisions about drilling locations, optimize production strategies, and understand complex subsurface geological structures. The seismic interpretation system (110) may be a specialized computer system used by geoscientists and seismic interpreters for analyzing and interpreting seismic data.

Seismic interpretation involves intensive tasks like data visualization, horizon picking, attribute analysis, and 3D modeling. A high-performance seismic interpretation system (110) with a powerful processor, ample memory, and a high-resolution display is essential to handle these computationally demanding tasks efficiently. Dedicated GPUs may be crucial for real-time rendering of seismic data, enabling smooth and interactive visualization. GPUs with high memory and parallel processing capabilities accelerate tasks like volume rendering and horizon visualization.

Seismic interpretation often involves working with large and complex datasets. Multiple high-resolution monitors allow interpreters to view seismic data, cross-sections, time slices, attribute maps, and other visualizations simultaneously, enhancing productivity and analysis accuracy. The seismic interpretation system (110) may be equipped with industry-standard software applications tailored for seismic interpretation, such as seismic data processing and visualization tools, horizon and fault interpretation systems, attribute analysis software, and 3D modeling software.

Seismic interpretation projects generate substantial amounts of data, including seismic volumes, processed data, interpretation results, and velocity models. A high-capacity and fast storage system, such as solid-state drives (SSDs) or RAID arrays, is necessary to store and access this data efficiently. The seismic interpretation system (110) often requires network connectivity to access centralized data repositories, collaborate with colleagues, and share interpretation results. A robust network infrastructure with fast Ethernet or fiber connections ensures smooth data transfer and collaboration capabilities.

Essential peripherals like keyboards, mice, and graphics tablets enable efficient interaction with data and software interfaces. A seismic interpretation workstation (110) may be augmented with purpose specific peripherals such as high capability display devices that may include immersive or virtual reality devices, such as virtual-reality headsets or immersive “caves”. Additionally, color-calibrated and high-accuracy input devices enhance the precision of interpretation tasks like picking horizons or drawing geological features. The seismic interpretation system (110) should have backup solutions in place to protect valuable data from loss or damage. Automated backup systems, external storage devices, or network-attached storage (NAS) can be utilized to ensure data safety. In some cases, seismic interpreters may need remote access to the seismic interpretation system (110) or collaborate with colleagues remotely. Setting up remote access capabilities, such as Virtual Private Networks (VPNs) or remote desktop solutions, allows interpreters to work from different locations and share their work effectively. The seismic interpretation system (110) may be customized to meet the needs of interpreters and the specific requirements of projects. The hardware specifications may vary based on factors like the complexity of interpretations, the size of datasets, and the software tools utilized.

The result of interpreting the seismic image may be a geological model (112) of the subsurface, including reservoir models of hydrocarbon reservoirs within the subterranean region of interest. Geological models (112) may include the locations of geological interfaces, such as the boundary between volumes (“formations”) containing different rock types (“facies”), and faults and fractures. Geological models may also include descriptions of the characteristics of the different facies including characteristics such as porosity and permeability, and the relative amounts of different fluids, such as gas, oil and brine, within the pores in each facies.

In some embodiments, the geological models (112) may be used directly to create a wellbore drilling plan (120) using a wellbore planning system (118). Such a wellbore drilling plan (120) may contain drilling targets, often geological regions expected to contain hydrocarbons. The wellbore planning system (118) may plan wellbore trajectories to reach the drilling targets while simultaneously avoiding drilling hazard, such as preexisting wellbores, shallow gas pockets, and fault zones, and not exceeding the constraints, such as torque, drag and wellbore curvature, of the drilling system. Similarly, the wellbore drilling plan (120) may include a determination of wellbore caliper, and casing points.

The wellbore planning system (118) may include dedicated software stored on a memory of a computer system, such as the computer system shown in FIG. 13. The wellbore plan (120) may be informed by the best available information at the time of planning. This may include models encapsulating subterranean stress conditions, the trajectory of any existing wellbores (which may be desirable to avoid), and the existence of other drilling hazards, such as shallow gas pockets, over-pressure zones, and active fault planes.

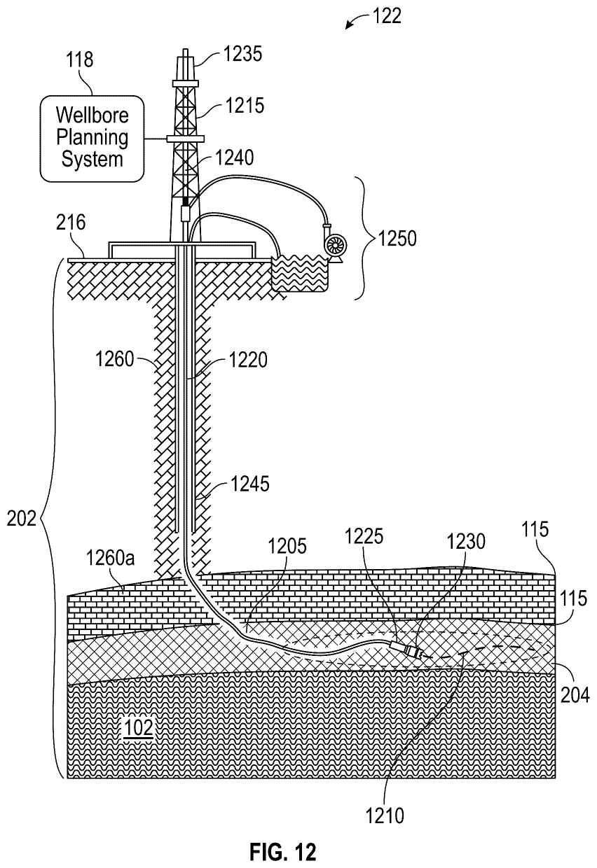

The wellbore path, such as the wellbore path (1210) shown in FIG. 12, may include a starting surface location of the wellbore, or a subsurface location within an existing wellbore, from which the wellbore (1205) may be drilled. The wellbore path (1210) may further include a terminal location that may intersect with the previously located hydrocarbon reservoir, such as hydrocarbon reservoir (204) shown in FIG. 2. The wellbore path (1210) may further still include wellbore geometry information such as wellbore diameter and inclination angle and when each of these change along the depth of the wellbore. If casing is used, the wellbore plan (120) may include casing type or casing depths. Furthermore, the wellbore plan (120) may consider other engineering constraints such as the maximum wellbore curvature (“dog-log”) that a drillstring of a drilling system may tolerate and the maximum torque and drag values that the drilling system may provide. The wellbore plan (120) may further define associated drilling parameters, such as the planned depths at which drilling may be paused to permit insertion of casing. Casing may be inserted to support the wellbore (1205), to prevent formation fluids entering the wellbore (1205), and to permit optimization of the drilling mud weights (densities) and types that may be used during drilling of the wellbore (1205).

In some embodiments, the geological model (112) may be input to a reservoir simulator (114). A reservoir simulator (114) includes functionality for simulating the flow of fluids, including hydrocarbon fluids such as oil and gas, through a hydrocarbon reservoir composed of porous, permeable reservoir rocks in response to natural and anthropogenic pressure gradients. The reservoir simulator (114) may be used to predict changes in fluid flow, including fluid flow into wells penetrating the reservoir as a result of planned well drilling, and/or fluid injection and extraction. For example, the reservoir simulator may be used to predict fluid flow and production scenarios (116) including changes in hydrocarbon production rate that would result from the injection of water into the reservoir from wells around the reservoir's periphery.

The reservoir simulator (114) may use a geological model or reservoir model (112) that contains a digital description of the physical properties of the rocks as a function of position within the reservoir and the fluids within the pores of the porous, permeable reservoir rocks at a given time. In some embodiments, the digital description may be in the form of a 3D grid with the physical properties of the rocks and fluids defined at each node of the 3D grid. In some embodiments, the 3D grid may be a cartesian grid, while in other embodiments the grid may be an irregular grid.

The physical properties of the rocks and fluids within the reservoir may be obtained from a variety of geological and geophysical sources. For example, remote sensing geophysical surveys, such as seismic surveys, gravity surveys, and active and passive source resistivity surveys may be employed. In addition, data collected from well logs acquired in wells penetrating the reservoir may be used to determine physical and petrophysical properties along the segment of the well trajectory traversing the reservoir. For example, porosity, permeability, density, seismic velocity, and resistivity may be measured along these segments of wellbore. In accordance with some embodiments, remote sensing geophysical surveys and physical and petrophysical properties determined from well logs may be combined to estimate physical and petrophysical properties for the entire reservoir simulation model grid.

Reservoir simulators solve a set of mathematical governing equations that represent the physical laws that govern fluid flow in porous, permeable media. For example, the flow of a single-phase, slightly-compressible oil with a constant viscosity and compressibility may be simulated by equations that represent Darcy's law, the continuity condition and an equation of state.

Additional and more complicated equations are required when more than one fluid or more than one phase, e.g., liquid and gas, are present in the reservoir. Further, when the physical and petrophysical properties of the rocks and fluids vary as a function of position, the governing equations may not be solved analytically and must instead be discretized into a grid of cells or blocks. The governing equations must then be solved by one of a variety of numerical methods such as, without limitation, explicit or implicit finite-difference methods, explicit or implicit finite element methods, or discrete Galerkin methods.

The fluid flow and production scenarios (116) predicted by the reservoir simulator (114) may then be used by the wellbore planning system (118) to determine the wellbore drilling plan (120).

While a wellbore drilling plan (120) is formed using the best available information at the time at which it is formed, additional information may become available when drilling the wellbore specified by the plan. For example, well logs providing new information about the reservoir structure and characteristic may be acquired while drilling (so-called “logging-while-drilling” (LWD) logs) or during drilling pauses in, or at the completion of the drilling of, a wellbore (1205) specified by the drilling plan (120). These well logs acquired during pauses or at the cessation of drilling may be acquired using wireline or coiled tubing conveyed logging tools. These new logs may be used to update geological and reservoir models (112) with the aid of a seismic interpretation workstation or to directly update the reservoir simulation performed by the reservoir simulator (114).

FIG. 2 shows a seismic acquisition system (102) configured to acquire a seismic dataset pertaining to a subterranean region of interest (202). The subterranean region of interest (202) may or may not contain a hydrocarbon reservoir (204). The purpose of the seismic survey may be to determine whether a hydrocarbon reservoir (204) is present within the subterranean region of interest (202).

The seismic acquisition system (200) may utilize a seismic source (206) positioned on the surface of the earth (216). On land the seismic source (206) is typically a vibroseis truck (as shown) or, less commonly, explosive charges, such as dynamite, buried to a shallow depth. In water, particularly in the ocean, the seismic source may commonly be an air gun (not shown) that releases a pulse of high-pressure gas when activated. Whatever its mechanical design, the seismic source (206), when activated, generates radiated seismic waves, such as those whose paths are indicated by the rays (208). The radiated seismic waves may be bent (“refracted”) by variations in the speed of seismic wave propagation within the subterranean region and return to the surface of the earth (216) as refracted seismic waves (210). Alternatively, radiated seismic waves may be partially or wholly reflected by seismic reflectors, at reflection points such as (224), and return to the surface as reflected seismic waves (214). Seismic reflectors may be indicative of the geological boundaries (212), such as the boundaries between geological layers, the boundaries between different pore fluids, faults, fractures or groups of fractures within the rock, or other structures of interest in the seismic for hydrocarbon reservoirs. Finally, seismic sources (206) may generate surface waves (218), sometimes referred to as “ground-roll”, that propagate along the surface of the earth.

At the surface, the refracted seismic waves (210) and reflected seismic waves (214) may be detected by seismic receivers (220). On land a seismic receiver (220) may be a geophone (that records the velocity of ground motion) or an accelerometer (that records the acceleration of ground motion). In water, the seismic receiver may commonly be a hydrophone that records pressure disturbances within the water. Irrespective of its mechanical design or the quantity detected, seismic receivers (220) convert the detected seismic waves into electrical signals, that may subsequently be digitized and recorded by a seismic recorder (222) as a time-series of samples. Such a time-series is typically referred to as a seismic “trace” and represents the amplitude of the detected seismic wave at a plurality of sample times. Usually, the sample times are referenced to the time of source activation and the sample times are referred to as “recording times”. Thus, zero recording time occurs at the moment the seismic source is activated.

Each seismic receiver (220) may be positioned at a seismic receiver location that may be denoted (xᵣ, yᵣ) where x and y represent orthogonal axes, such as North-South and East-West, on the surface of the earth (216) above the subterranean region of interest (202). Note, the vertical elevation of the seismic receiver may often not be recorded, a practice that contributes to the necessity of treating the effects of varying elevation as a form of noise. Thus, the refracted seismic waves (210) and reflected seismic waves (214) generated by a single activation of the seismic source (206) may be represented as a three-dimensional “3D” volume of data with axes (xᵣ, yᵣ, t) where t indicates the recording time of the sample, i.e., the time after the activation of the seismic source (206).

Typically, a seismic survey includes recordings of seismic waves generated by one or more seismic sources (206) positioned at a plurality of seismic source locations denoted (xₛ, yₛ). As for the seismic receivers discussed in the previous paragraph, the elevation of the seismic source location is typically not recorded and/or neglected. In some case, a single seismic source (206) may be used to acquire the seismic survey, with the seismic source (206) being moved sequentially from one seismic source location to another. In other cases, a plurality of seismic sources, such as seismic source (206) may be used, each occupying and being activated (“fired”) sequential at a subset of the total number of seismic source locations used for the survey. Similarly, some or all of the seismic receivers (220) may be moved between firing of the seismic source (206). For example, seismic receivers (220) may be moved such that the seismic source (206) remains at the center of the area covered by the seismic receivers (220) even as the seismic source (206) is moved from one seismic source location to the next. In other cases, such as marine seismic acquisition (not shown) the seismic source may be towed a short distance behind a seismic vessel and strings of receivers attached to multiple cables (“streamers”) are towed behind the seismic sources. Thus a seismic survey geometry, describing the seismic source and seismic receiver locations may be a four-dimensional acquisition geometry, and a seismic dataset, the aggregate of all the seismic data acquired by the seismic survey, may be represented as a five-dimensional volume (four space dimensions and one time dimension) with coordinate axes (xᵣ, yᵣ, yₛ>yₛ, t). Displaying, processing, and interpreting a five dimensional volume may be challenging.

Subterranean regions of interest to hydrocarbon exploration frequently include a large number of approximately horizontal layers. These layers vary much more slowly in the horizontal plane than they vary in along the vertical axis. However, these layers are often overlain by a “near-surface” region in which variation in the horizontal plane can be much more rapid than is common at depth, due in part to the effects of dissolution, weathering and erosion. This heterogeneous near-surface zone, that may extend from a few tens to a few hundreds, of feet, is particularly problematic when acquiring seismic surveys on land over regions where the near-surface is composed of carbonate rocks, such as limestone or dolomite. The near-surface in these situations may exhibit “karst” geomorphology including buried or exposed beds of irregularly flowing streams (“wadis”), caves, and sink-holes (exposed caves). In addition, in desert regions the karst may be buried under unconsolidated sand, including sand dunes.

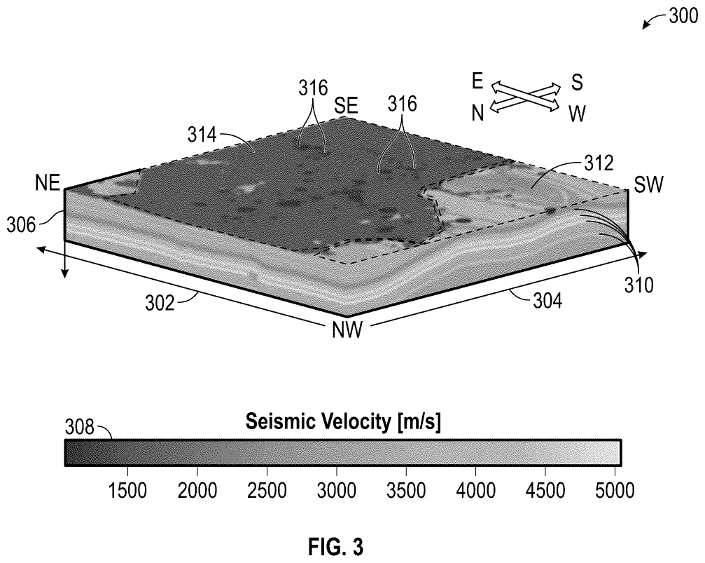

For illustration, FIG. 3 shows a numerical model (300) of a subterranean region of interest displayed on two orthogonal horizontal axes (302) and (304) and a vertical axis (306). The numerical model may include a number of physical characteristics, such as seismic velocity and density, as well as petrophysical properties, such as porosity and permeability, and geological properties, such as rock type, e.g., limestone, dolomite, and gypsum, or facies description, e.g., reef, beach, or lagoon. In particular, FIG. 3 displays seismic velocity indicated in meters per second (m/s) on the grayscale (308). In addition to the smoothly varying rock layers (310) that outcrop at the surface in area (312), FIG. 3 displays an area (314) where the smoothly varying rock layers (310) and buried beneath low seismic velocity unconsolidated sand and sand dunes, and caves and sinkholes (316) that may be wholly or partially filled with unconsolidated sand.

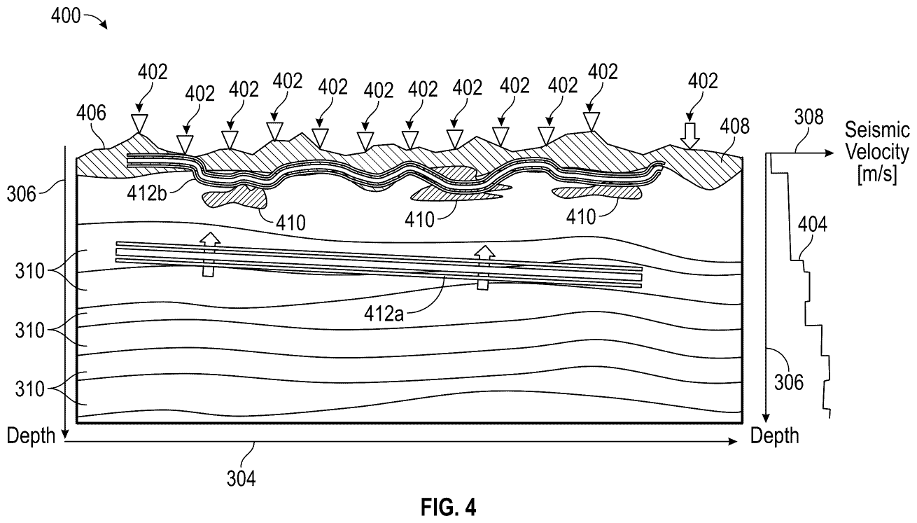

FIG. 4 depicts a vertical cross-section (400) through a numerical model of the subterranean region shown in FIG. 3, displayed as a function of depth on a vertical axis (306) and horizontal position displayed on a horizontal axis (304). In addition to the smoothly-varying rock layers (310), cross-section (400) shows a low-velocity surface layer (408) with a varying ground surface topography (406) on which a polarity of seismic receivers (402) is disposed. Further buried voids (caves) (410) are indicated at shallow depths below the surface. Typically, the seismic velocity, as indicated on the seismic velocity scale (404), increases rapidly with depth, with the near-surface layers having a significantly lower seismic velocity than the deeper layers (310). As a result, as will be apparent to one skilled in the art, a smooth seismic wavefront, such as seismic wavefront (412a), may become a significantly distorted seismic wavefront, such as seismic wavefront (412b) prior to being recorded by the polarity of seismic receivers (402).

FIG. 5A shows an example of a portion of a seismic dataset (500), in accordance with one or more embodiment. FIG. 5A shows seismic data such as the seismic data that might be recorded by the plurality of seismic receivers over a subterranean region represented by the numerical model (300) after the activation of a seismic source, such as seismic source (206). The vertical axis (502) indicates the time elapsed after the activation of the seismic source (206) and the horizontal axis (504) indicates the separation (“offset”) between the seismic source (206) and each of the plurality of seismic receivers (402). Thus, the portion of a seismic dataset (500) indicates a two-dimensional (“2D”) portion of the 5D seismic dataset discussed in relation to FIG. 2.

Each trace in FIG. 5A indicates the ground motion, such as particle displacement, velocity, or acceleration, recorded by one seismic receiver. The zero value of the ground motion is plotted at a horizontal position proportional to the offset with positive values of ground motion plotted as an additional rightward deflection, and negative values as a leftward deflection, relative to the zero-valued position, or vice versa. In addition, by convention, positive (or in some cases negative) “lobes” of the ground motion may be shaded, or filled, as a solid polygon to aid in the visual interpretation of the display. Finally, displays of seismic datasets, such as seismic dataset (500), may be filtered using automatic gain control. Automatic gain control has the effect of increasing the relative amplitude of small amplitude portions of the signals and decreasing the relative amplitude of large amplitude portions of the seismic signal. This is implemented by dividing each individual sample by the mean value of samples within sliding window surrounding each individual sample.

The seismic dataset (500) contains at least three different types of seismic waves. The earliest-arriving signals (512) are direct or “refracted” waves that have traveled from the seismic source to the seismic receivers without undergoing reflection. Note, refracted waves typically follow a curved, rather than a straight, ray path that is governed by Snell's law and typically sample shallower portions of the subterranean region. The seismic signals following the refracted waves (512) and typically surface waves or “ground-roll” signals (514). Ground-roll signals travel at low velocities, are guided along the surface of the earth and are composed largely of Rayleigh and Love waves. At the frequencies typically used in seismic surveys for hydrocarbon exploration (approximately 2-60 Hz) ground-roll carries little information about geological structure at depths of exploration interest and is usually treated as noise. Finally, the third type of seismic waves recorded by the seismic receivers are reflections (516) from geological discontinuities. At short offsets, reflections arrive at seismic receivers at later times than refractions or ground-roll. However, at larger offsets, reflections and ground roll may overlap in time.

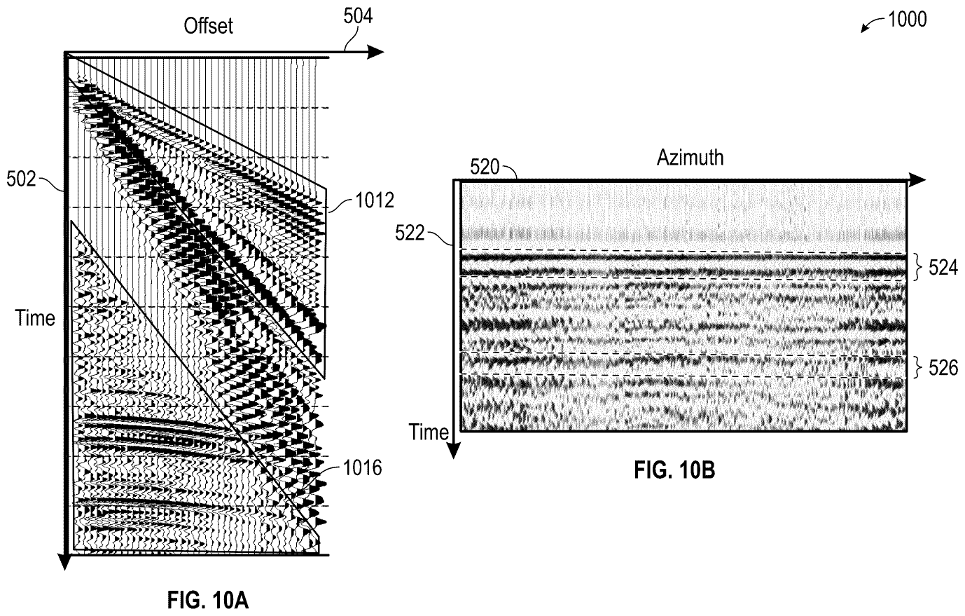

FIG. 5B shows a common offset/common midpoint (CMP) gather (i.e., it represents the same midpoint bin and same offset bin). The horizontal axis (520) indicates the azimuthal position of the trace. Specifically, in FIG. 5B the traces are shown equally spaced as occurring along the circumference of a circle where the center is the midpoint. The traces in the gather may be decomposed also in terms of angles (e.g., 0-360 degrees in 30 degree intervals). The vertical axis (522) represents the travel time of seismic waves from the seismic source to the seismic receiver recording the trace. The dashed line (524) indicates a refracted signal or “refraction”, such as the refractions (512) indicated in FIG. 5A. The dashed lines (526) indicates a reflected signal or “reflection”. Refraction (524) and reflection (526) will be examined again below in FIG. 10B showing at least some of the benefits and improvements obtained from the application of a disclosed embodiment.

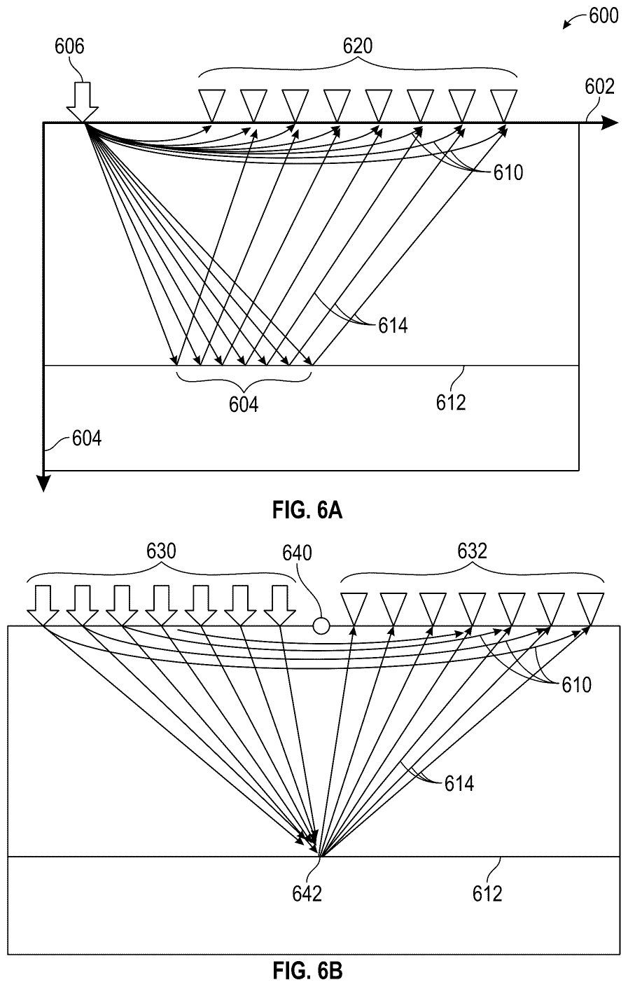

A seismic dataset may be arranged, sorted, “gathered” or binned in a number of ways. FIGS. 6A and 6B show two gathers that are in widespread use. FIG. 6A illustrates the spatial geometry of a common-source gather (600). In FIG. 6A the horizontal axis (602) represents location in a horizontal plane approximating the surface of the earth of a seismic source (606) and a plurality of seismic receivers (620). The vertical axis (604) represents depth below the surface of the earth (216). In FIG. 6A two types of seismic waves are indicated by rays marking the trajectory along with the energy of the seismic waves travel. The first type of waves has rays that emanate from the seismic source (606), reflect from a geological boundary (612) and propagating as reflected seismic waves (614) to the seismic receivers (620). While the rays associated with the first type of waves may also be curved or bent by variation in the seismic propagation velocity in the subsurface this first type of waves are distinguished by their reflection from a geological boundary, and thus may be called “reflected waves”. In contrast, the second type of waves do not reflect from geological boundaries, such as geological boundary (612) but rather have rays that are only curved, bent, or “refracted” by variation in the seismic propagation velocity. This second type of waves may be termed “refracted waves”.

These common-source gathers correspond to the physical acquisition of a typical seismic dataset with the seismic waves caused by a single activation of a seismic source (606) being recorded by a plurality of seismic receivers (620). Although common-source gathers correspond to the physical acquisition geometry, from the perspective of processing the seismic dataset, common-source gathers suffer from the fact that the reflection points (604) on the geological boundary (612) vary spatially from one receiver to another and the time at which the reflected energy is recorded by each seismic receiver varies from one trace to another.

Recorded seismic datasets consisting of seismic data generated by the activation of a seismic source at many seismic source locations and recorded by many seismic receivers at many seismic receiver locations may frequently be reorganized into common-midpoint gathers, such as the common-midpoint gather displayed in FIG. 6B. The seismic traces in a common-midpoint gather may be selected to share a single (“common”) midpoint (640) but varying offset between the corresponding seismic source, such as the seismic sources (630), and the corresponding seismic receivers (632). In many cases common-midpoint gathers are preferred because each trace shares (approximately) the same reflection point (642) on the geological boundary (612). Consequently, the reflected signals in each trace in the common-midpoint gather contains information about the same point. As will be understood by one skilled in the art, while in the above description we have referred to a common-midpoint as a point on the surface of the earth, in practice it is usual to group, or “bin” seismic traces with approximately the same, or a sufficiently similar, spatial location into a single common-midpoint gather. Determining what constitutes sufficiently similar is a task routinely performed in the art and is typically dependent upon the frequency content of the seismic signal, the anticipated target depth, and the desired resolution and/or signal to noise level of the processed seismic dataset.

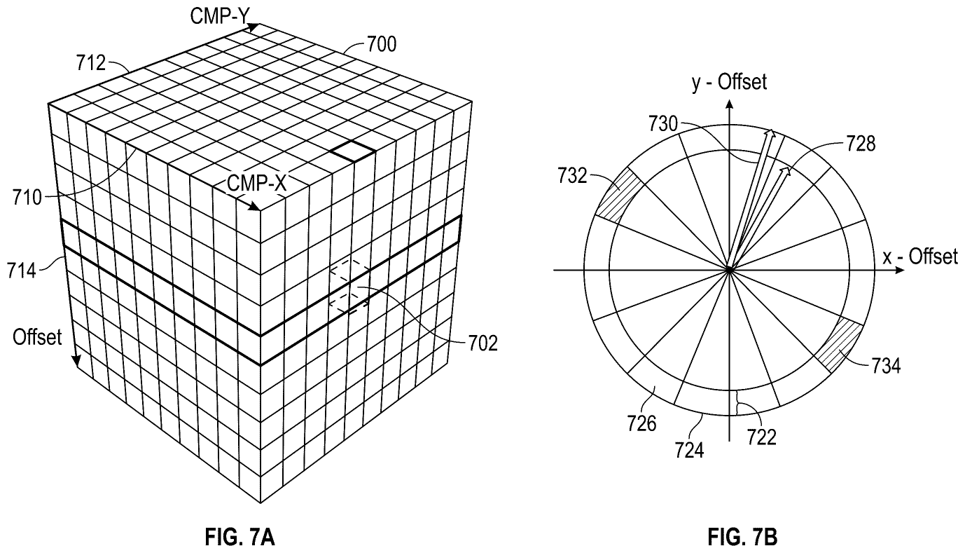

Common-midpoint gathers may be further divided as illustrated in FIGS. 7A and 7B. For example, each common-midpoint gather, with surface coordinates of the common-midpoint denoted (CMP_X, CMP_Y), may be divided based upon the seismic source-seismic receiver offset distance, producing a 3D cube (700) of common-midpoint, common-offset gathers, such as the common-midpoint, common-offset gather (702). Note, the horizontal axes (710, 712) of the 3D cube denote the surface location of the common-midpoint on orthogonal axes, such as North-South and East-West, while the vertical axis (714) denotes the range of offsets between the seismic source and seismic receiver pairs in the common-midpoint, common-offset gather (702). However, within each common-midpoint, common-offset gather (702) the offset is defined only by the magnitude or scalar distance between each seismic source and corresponding seismic receiver, but not by their relative spatial orientation. For example, by way of illustration, a common-midpoint, common-offset gather (702) may contain data from seismic sources and seismic receivers separated in a North-South direction by a distance of 1000 ft and data from seismic sources and seismic receivers separated in an East-West direction by a distance of 1000 ft.

FIG. 7B shows how a common-midpoint, common-offset gather (702) may further be divided based upon the relative spatial orientation of the seismic source and corresponding seismic receiver. FIG. 7B shows the two-components of the relative offsets, denoted x-offset and y-offset, between the seismic source locations and seismic receiver locations for each pair of seismic source location and seismic receiver location forming a common-midpoint gather. All the seismic source locations and seismic receiver locations forming a common-midpoint, common-offset gather may lie with the annulus (722) formed by the concentric circles (724) and (726). Equivalently, all the seismic source locations and seismic receiver locations forming a common-midpoint, common-offset gather may be separated by a scalar distance great than the radial distance (728) and less than the radial distance (730). Dividing the common-midpoint, common-offset gather based on an azimuth of the vector joining seismic source location and seismic receiver location yields common-midpoints, common-offset, common-azimuth gathers, such as gathers (732) and (734). In some embodiments, common-midpoints, common-offset, common-azimuth gathers (732) and (734) may be treated as separate gathers. However, since the difference between gather (732) and gather (734) corresponds to swapping the location of the seismic source and the seismic receiver, in other embodiments common-midpoints, common-offset, common-azimuth gathers (732) and (734) may be treated together as a single gather.

In a basic conventional surface-consistent decomposition the recorded seismic trace, Pᵢⱼ(t), where subscripts i and j enumerates the seismic source location and the seismic receiver location is considered to be the result of a convolution, denoted “*”, of the seismic source location function Sᵢ(t), and a seismic receiver location impulse response Rⱼ(t), with Green's function, Γᵢⱼ(t), that models the propagation of the seismic wave through the subterranean region. Thus, Pᵢⱼ (t) may be written:

$${P}_{ij} ( t ) = {S}_{i} ( t ) * {R}_{j} ( t ) * {Γ}_{ij} ( t ) \qquad Eq . ( 1 )$$

The decomposition of such convolutional model provides surface-related (or “surface-consistent”) corrections for Sᵢ(t) and Rⱼ(t), while ignoring other possible influences on Pᵢⱼ (t). Other more sophisticated conventional convolutional methods may introduce additional statistical terms to account for other possible sources of trace misalignment to address the problem from a statistical point of view. Increasing the number of variables in an ill-posed inverse problem can cause instability in the solution and can generate inaccurate results. However, even sophisticated conventional methods may fail to address azimuthal variations, related to azimuthal velocity variations and/or seismic velocity anisotropy.

In embodiments disclosed herein, a seismic dataset is initially decomposed into common-midpoint, common-offset, common-azimuth bins. The traces grouped into each such bin correspond to waves that have traveled through the same subterranean formations. Hence, time or amplitude misalignments among them can be reliably related to the source function Sᵢ(t) and to the receiver impulse response Rⱼ(t) obtained from inversion. Consequently, embodiments disclosed herein provide an improvement over conventional processes for achieving a similar purpose for at least the reasons of enhanced resolution and the accuracy of the surface-consistent phase corrections.

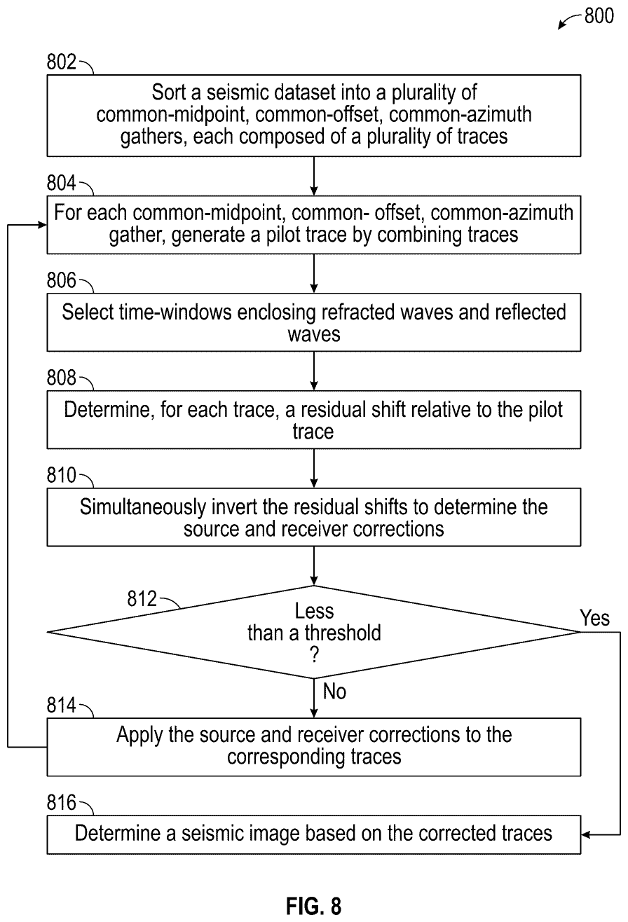

FIG. 8 shows a flowchart (800) in accordance with some embodiments. In Step (802) a seismic dataset may be sorted into a plurality of common-midpoint, common-offset, common-azimuth gathers, gather composed of a plurality of traces.

In Step (804), for each common-midpoint, common-offset, common-azimuth gather, a pilot trace may be generated by combining traces. The pilot trace may be generated by simple stacking (summation or averaging of the traces on a sample-by-sample basis). Alternatively, more sophisticated methods may be used to combine the traces, such as trimmed-mean stacking or prefiltering, to remove noisy traces prior to stacking.

In Step (806) a first time-window of samples from the pilot trace may be selected enclosing the refracted seismic wave arrivals. This first time-window is termed herein a “pilot refraction window”. Similarly, a second time-window of samples from the pilot trace may be selected enclosing the reflected seismic wave arrivals. This second time window is termed herein a “pilot reflection window”. The pilot refraction window and the pilot reflection window may be distinct and non-overlapping in some cases, but in other cases the pilot refraction window and pilot reflection window may partially overlap in time. Additionally, a corresponding refraction window and reflection window may be selected from each trace where the pilot refraction window and the corresponding refraction window cover the same time interval and the pilot reflection window and the corresponding reflection window cover the same time interval.

In Step (808) a residual shift may be determined between each trace and the pilot trace. For example, a time shift may be determined by performing a cross-correlation between the refraction window of each trace and the refraction window of the pilot trace and combining the result with a cross-correlation between the reflection window of the trace and the reflection window of the pilot trace. The contribution of the cross-correlation cross-correction between the refracted traces and the cross-correlation between the reflected traces may be weighted relative to one another in some embodiments, such that the refraction window is given a greater weight or a greater significance than the reflection window or vice versa.

In Step (810) the residual shifts may be simultaneously inverted to determine the source and receiver corrections. In step (812) the size or magnitude of these corrections may be compared to a threshold. In some embodiments, the threshold may be a predetermined threshold that may be based on the dominant period of the seismic signal. For example, the threshold for a time-shift correction may be a quarter of the dominant period of the seismic signals. In other embodiments, the threshold may be determined by the size or magnitude of the change in the correction from one iteration to the next.

If the corrections are not less than the threshold, the source and receiver corrections may be applied to the corresponding traces in Step (814) and the iterative loop returns to Step (804) from which the process is then applied to the updated or corrected traces. On the other hand, if the corrections are less than the threshold, the correction process described in flowchart (800) may be terminated and the corrected seismic dataset further processed, for example to determine a seismic image of the subterranean region in Step (816). Step (816) may, in some embodiments, include other processing steps such as, without limitation, velocity analysis and the determination of seismic attributes.

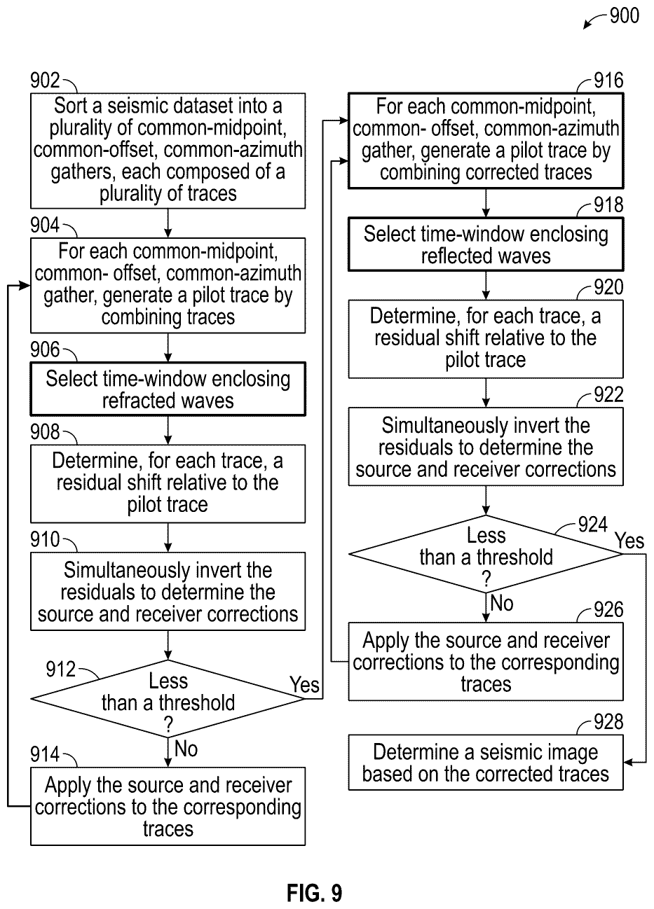

FIG. 9 shows a flowchart (900) in accordance with other embodiments. Many of the steps of flowchart (900) and flowchart (800) are similar or the same, and to avoid duplication they will not be described in detail again. Instead, attention will be focused on the difference between them.

In flowchart (900) the Steps (902) and (904) may be identical or substantially similar to the Steps (802) and (804) in flowchart (800). However, Step (906) in flowchart (900) differs from Step (806) in flowchart (800). Specifically, in Step (906) a time-window may be selected to enclose only the refracted waves. This is in contrast with Step (806) of flowchart (800) where two time-windows may be selected, one enclosing refracted waves and another enclosing reflected waves. The remainder of the iterative loop, including Steps (908), (910), (912), and (914), is similar to Steps (808), (810), (812), and (814) but differ in that the Steps are performed only on the time-windows enclosing the refracted signals.

In addition, Step (912) differs from Step (812) in that, when the residuals satisfy the test, i.e., are less than the threshold, rather than terminating the process and making the corrected traces available for further seismic processing, the interim corrected traces from Step (912) are made available to Step (916) where for each common-midpoint, common-offset, common-azimuth gather, an updated pilot trace may be generated by combining corrected traces. The updated pilot trace may be generated by simple stacking (summation or averaging of the traces on a sample-by-sample basis). Alternatively, more sophisticated methods may be used to combine the traces, such as trimmed-mean stacking, or prefiltering to remove noisy traces prior to stacking.

In Step (918) a second time-window of samples from the updated pilot trace may be selected enclosing the reflected seismic wave arrivals. This second time window is termed herein an “updated reflection window”. Additionally, a corresponding updated reflected time window may be selected from each trace.

In Step (920) a residual shift may be determined between each trace and the pilot trace. For example, a time shift may be determined by performing a cross-correlation between the updated reflection window of each trace and the updated reflection window of the updated pilot trace.

In Step (922) the residual shift of all the traces may be simultaneously inverted to determine the source and receiver corrections. In step (924) the size or magnitude of these corrections may be compared to a threshold. In some embodiments, the threshold may be a predetermined threshold that may be based on the dominant period of the seismic signal. For example, the threshold for a time-shift correction may be a quarter of the dominant period of the seismic signals. In other embodiments, the threshold may be determined by the size or magnitude of the change in the correction from one iteration to the next.

If the corrections are not less than the threshold, the source and receiver corrections may be applied to the corresponding traces in Step (926) and the iterative loop returns to Step (916), from which the process is then applied to the updated or corrected traces. On the other hand, if the corrections are less than the threshold then the correction process shown in flowchart (900) may be terminated and the corrected seismic dataset further processed, for example to determine a seismic image if the subterranean region in Step (928). Step (928) may, in some embodiments, include other processing steps such as, without limitation, velocity analysis and the determination of seismic attributes.

FIGS. 10A and 10B show portions of a seismic dataset in accordance with one or more embodiments. Specifically, FIG. 10A corresponds to the portion of the seismic dataset displayed in FIG. 5A after the application of one of the embodiments. As will be readily apparent to one of ordinary skill in the art, the refracted seismic waves (1012) are much more coherent (i.e., regularly varying) across the array, and hence much more easily identified and processed, than the refracted seismic waves in the corresponding portion of the uncorrected dataset shown in FIG. 5A.

Similarly, as will be readily apparent to one of ordinary skill in the art, the reflected seismic waves (1016) are much more coherent (i.e., regularly varying) across the array, and hence much more easily identified and processed, than the reflected seismic waves in the corresponding portion of the uncorrected dataset shown in FIG. 5A.

Further, FIG. 10B shows the traces of the common offset/common midpoint (CMP) gather shown in FIG. 5B but after the application of a disclosed embodiment. As in FIG. 5B, the horizontal axis (520) indicates the azimuthal position of the trace. The vertical axis (522) represents the travel time of seismic waves from the seismic source to the receiver recording the trace. As a reminder, the dashed line (524) indicates a refracted signal or “refraction”, such as the refractions (1012) indicated in FIG. 10A and the dashed lines (526) indicates a reflected signal or “reflection”, such as the reflections (1016) indicated in FIG. 10A.

FIG. 10B may be compared with FIG. 5B. FIGS. 5B and 10B correspond to the same subterranean region. However, FIG. 5B displays a common midpoint common-offset gather prior to correction using an embodiment disclosed herein while FIG. 10B displays the common midpoint common-offset gather after correction with a disclosed embodiment. It will be apparent that the example refraction (524) and example reflection (526), are much more coherent (i.e., smoothly varying across the image) in FIG. 10B than in FIG. 5B. As a consequence of this improved coherency, one of ordinary skill in the art will be able interpret the seismic signals in FIG. 10B, and a seismic image determined from them, with much greater ease and confidence than the seismic image shown in FIG. 5B.

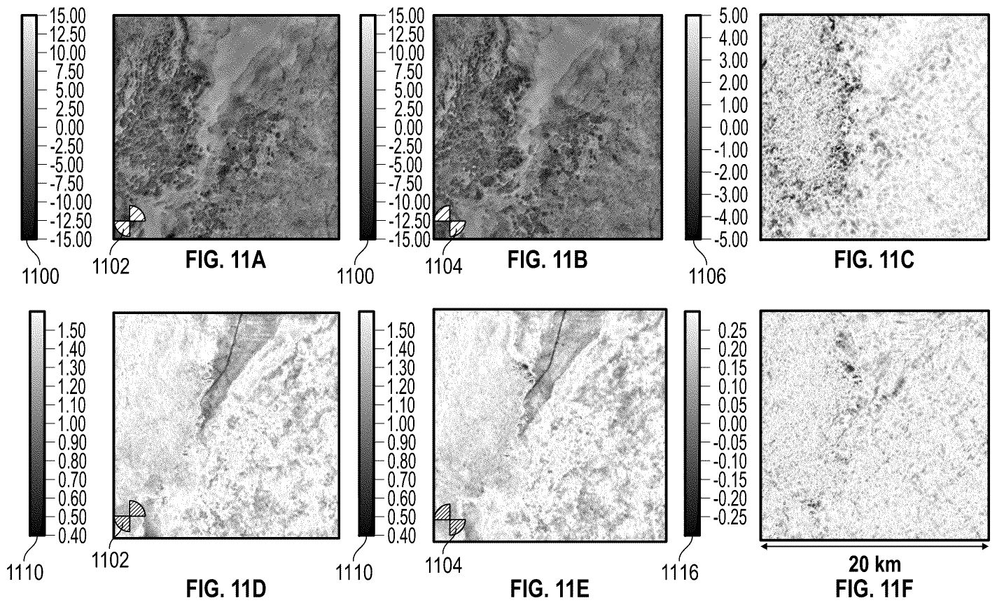

FIGS. 11A and 11B show maps of travel time statics corrections for a 20 kilometer (km) by 20 km square of the surface of the earth above a subterranean region of interest. In both FIG. 11A and FIG. 11B the value of the travel time static correction in milliseconds (ms) at each pixel is indicated by the grayscale (1100). Specifically, FIG. 11A shows travel time static corrections for common-azimuth bins ranging from 0 to 89 degrees and 180 to 269 degrees from vertical, as indicated by the azimuth bin indicator (1102). In comparison, FIG. 11B shows travel time static corrections for common-azimuth bins ranging from 90 to 179 degrees and 270 to 359 degrees from vertical, as indicated by the azimuth bin indicator (1104). While viewed in isolation FIGS. 11A and 11B may appear similar, their pixel-by-pixel difference is displayed in FIG. 11C. In FIG. 11C the difference in travel time static correction is indicated in milliseconds by the grayscale (1106). Comparison of the maximum and minimum values of the grayscales (1100) and (1106) indicate that the difference between the travel time statics corrections calculated for the two common-azimuth bins is as much as 30% of the range travel time statics corrections for either one of the bins.

Similarly, FIGS. 11D and 11E show maps of amplitude statics corrections for the same 20 kilometer (km) by 20 km square of the surface of the earth shown in FIGS. 11A-11C. In both FIG. 11D and FIG. 11E the value of the amplitude static correction at each pixel is indicated by the grayscale (1110). Specifically, FIG. 11D shows amplitude static corrections for common-azimuth bins ranging from 0 to 89 degrees and 180 to 269 degrees from vertical, as indicated by the azimuth bin indicator (1102). In comparison, FIG. 11E shows amplitude static corrections for common-azimuth bins ranging from 90 to 179 degrees and 270 to 359 degrees from vertical, as indicated by the azimuth bin indicator (1104). While viewed in isolation FIGS. 11D and 11E may appear similar, their pixel-by-pixel difference is displayed in FIG. 11F. In FIG. 11F the difference in amplitude static correction is indicated by the grayscale (1116). Comparison of the maximum and minimum values of the grayscales (1110) and (1116) indicate that the difference between the amplitude statics corrections calculated for the two common-azimuth bins is as much as 50% of the range of amplitude statics corrections for either one of the bins.

The comparison of travel time and amplitude statics corrections for different common-azimuth bins indicate that the sensitivity to azimuth of the results is indeed significant and that accounting for this azimuthal variation constitutes a significant improvement over conventional statics corrections methods that neglect or ignore this azimuthal variation.

The resulting seismic image may be used to a drilling target. A seismic interpretation workstation (110) may be used to facilitate the interpretation of the seismic image (1020) and geological structures, such as reflectors (524) and (526), including hydrocarbon reservoirs manifested therein. A drilling target may be a localized position in the hydrocarbon reservoir or may be an extended arc running through the hydrocarbon reservoir or a portion thereof.

A wellbore trajectory may subsequently be planned guided, at least in part, by the drilling target. Other factors influencing the wellbore trajectory may include available surface locations from which to begin drilling and at which to position the wellhead. For example, existing wellsite on land, and particularly drilling rigs offshore may be strongly preferred over a new well site. The planned wellbore trajectory may be contained in the wellbore drilling plan (120) and the wellbore drilling plan may also specify the “weight” or density of drilling mud, and the casing weight and circumference to use and planned drilled depths at which drilling may pause, casing be inserted, worn or “dull” drill bits replaced, and wellbore caliper reduced.

The planned wellbore trajectory contained in the wellbore drilling plan (120) may then be transferred to a drilling system (122) such that the wellbore path (1210) may be drilled as illustrated in FIG. 12 in accordance with one or more embodiments. Although the drilling system (122) is displayed as located on land, the drilling system (122) may also be a marine wellbore drilling system positioned on a jack-up rig, a floating rig, or a drill ship. As such, the illustrated drilling system (122) is not intended to limit the present disclosure.

FIG. 12 illustrates a drilling system (122) in accordance with one or more embodiments. A wellbore (1205) may be drilled, using the drilling system (122), guided by the planned wellbore path (1210) to penetrate the hydrocarbon reservoir (204).

As shown in FIG. 12, the drill system (122) may be equipped with a hoisting system, such as a derrick (1215), which can raise or lower the drillstring (1220) and other tools required to drill the wellbore (1205). The drillstring (1220) may include one or more drill pipes connected to form conduit and a bottom hole assembly (1225) (BHA) disposed at the distal end of the drillstring (1220). The BHA (1225) may include a drill bit (1230) to cut into rock (1260), including cap rock (1260a). The BHA (1225) may further include measurement tools, such as a measurement-while-drilling (MWD) tool and logging-while-drilling (LWD) tool. MWD tools may include sensors and hardware to measure downhole drilling parameters, such as the azimuth and inclination of the drill bit (1230), the weight-on-bit, and the torque. The LWD measurements may include sensors, such as resistivity, gamma ray, and neutron density sensors, to characterize the rock (1260) surrounding the wellbore (1205). Both MWD and LWD measurements may be transmitted to the surface of the earth (216) using any suitable telemetry system known in the art, such as a mud-pulse or by wired-drill pipe.

To start drilling, or “spudding in,” the wellbore (1205), the hoisting system lowers the drillstring (1220 suspended from the derrick (1215 towards the planned surface location of the wellbore (1205). An engine, such as a diesel engine, may be used to supply power to the top drive (1235) to rotate the drillstring (1220 via the drive shaft (1240). The weight of the drillstring (1220 combined with the rotational motion enables the drill bit (1230) to bore the wellbore (1205).

The near-surface of the subterranean region of interest (202) is typically made up of loose or soft sediment or rock (1260), so large diameter casing (1245) (e.g., “base pipe” or “conductor casing”) is often put in place while drilling to stabilize and isolate the wellbore (1205). At the top of the base pipe is the wellhead, which serves to provide pressure control through a series of spools, valves, or adapters (not shown). Once near-surface drilling has begun, water or drill fluid may be used to force the base pipe into place using a pumping system until the wellhead is situated just above the surface of the earth (216).

Drilling may continue without any casing (1245) once deeper or more compact rock (1260) is reached. While drilling, a drilling mud system (1250) may pump drilling mud from a mud tank on the surface of the earth (216) through the drill pipe. Drilling mud serves various purposes, including pressure equalization, removal of rock cuttings, and drill bit cooling and lubrication.

At planned depth intervals, drilling may be paused and the drillstring (1220) withdrawn from the wellbore (1205). Sections of casing (1245) may be connected and inserted and cemented into the wellbore (1205). Casing string may be cemented in place by pumping cement and mud, separated by a “cementing plug,” from the surface of the earth (216) through the drill pipe. The cementing plug and drilling mud force the cement through the drill pipe and into the annular space between the casing (1245) and the wall of the wellbore (1205). Once the cement cures, drilling may recommence. The drilling process is often performed in several stages. Therefore, the drilling and casing cycle may be repeated more than once, depending on the depth of the wellbore (1205) and the pressure on the walls of the wellbore (1205) from surrounding rock (1260).

Due to the high pressures experienced by deep wellbores (1205), a blowout preventer (BOP) may be installed at the wellhead to protect the rig and environment from unplanned oil or gas releases. As the wellbore (1205) becomes deeper, both successively smaller drill bits (1230) and casing (1245) may be used. Drilling deviated or horizontal wellbores (1205) may require specialized drill bits (1230) or drill assemblies.

The drilling system (122) may be disposed at and communicate with other systems in the wellbore environment. The drilling system (122) may control at least a portion of a drilling operation by providing controls to various components of the drilling operation. In one or more embodiments, the system may receive data from one or more sensors arranged to measure controllable parameters of the drilling operation. As a non-limiting example, sensors may be arranged to measure weight-on-bit, drill rotational speed (RPM), flow rate of the mud pumps (GPM), and rate of penetration of the drilling operation (ROP). Each sensor may be positioned or configured to measure a desired physical stimulus. Drilling may be considered complete when a drilling target with the hydrocarbon reservoir (204) is reached or the presence of hydrocarbons is established.

In some embodiments the wellbore planning system (118), the seismic processing system (106), and the seismic interpretation workstation (110) may each include a computer system.

Embodiments may be implemented on a computer system. FIG. 13 is a block diagram of a computer system (1100) used to provide computational functionalities associated with described algorithms, methods, functions, processes, flows, and procedures as described in the instant disclosure, according to an implementation. The illustrated computer system (1300) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer system (1300) may include a computer that includes an input device, such as a keypad, keyboard, touch screen, or other device that can accept user information, and an output device that conveys information associated with the operation of the computer system (1300), including digital data, visual, or audio information (or a combination of information), or a GUI.

The computer system (1300) can serve in a role as a client, network component, a server, a database or other persistency, or any other component (or a combination of roles) of a computer system for performing the subject matter described in the instant disclosure. The illustrated computer system (1300) is communicably coupled with a network (1302). In some implementations, one or more components of the computer system (1300) may be configured to operate within environments, including cloud-computing-based, local, global, or other environment (or a combination of environments).

At a high level, the computer system (1300) is an electronic computing device operable to receive, transmit, process, store, or manage data and information associated with the described subject matter. According to some implementations, the computer system (1300) may also include or be communicably coupled with an application server, e-mail server, web server, caching server, streaming data server, business intelligence (BI) server, or other server (or a combination of servers).

The computer system (1300) can receive requests over network (1302) from a client application (for example, executing on another computer system (1300)) and responding to the received requests by processing the said requests in an appropriate software application. In addition, requests may also be sent to the computer system (1300) from internal users (for example, from a command console or by other appropriate access method), external or third-parties, other automated applications, as well as any other appropriate entities, individuals, systems, or computers.

Each of the components of the computer system (1300) can communicate using a system bus (1304). In some implementations, any or all of the components of the computer system (1300), both hardware or software (or a combination of hardware and software), may interface with each other or the interface (1306) (or a combination of both) over the system bus (1304) using an application programming interface (API) (1308) or a service layer (1310) (or a combination of the API (1308) and service layer (1310). The API (1308) may include specifications for routines, data structures, and object classes. The API (1308) may be either computer-language independent or dependent and refer to a complete interface, a single function, or even a set of APIs. The service layer (1310) provides software services to the computer system (1300) or other components (whether or not illustrated) that are communicably coupled to the computer (1300). The functionality of the computer (1300) may be accessible for all service consumers using this service layer. Software services, such as those provided by the service layer (1310), provide reusable, defined business functionalities through a defined interface. For example, the interface may be software written in JAVA, C++, or other suitable language providing data in extensible markup language (XML) format or other suitable format. While illustrated as an integrated component of the computer (1300), alternative implementations may illustrate the API (1308) or the service layer (1310) as stand-alone components in relation to other components of the computer (1300) or other components (whether or not illustrated) that are communicably coupled to the computer (1300). Moreover, any or all parts of the API (1308) or the service layer (1310) may be implemented as child or sub-modules of another software module, enterprise application, or hardware module without departing from the scope of this disclosure.

The computer (1300) includes an interface (1306). Although illustrated as a single interface (1306) in FIG. 13, two or more interfaces (1306) may be used according to particular needs, desires, or particular implementations of the computer (1300). The interface (1306) is used by the computer (1300) for communicating with other systems in a distributed environment that are connected to the network (1302). Generally, the interface (1306) includes logic encoded in software or hardware (or a combination of software and hardware) and operable to communicate with the network (1302). More specifically, the interface (1306) may include software supporting one or more communication protocols associated with communications such that the network (1302) or interface's hardware is operable to communicate physical signals within and outside of the illustrated computer (1300).

The computer (1300) includes at least one computer processor (1312). Although illustrated as a single computer processor (1312) in FIG. 13, two or more processors may be used according to particular needs, desires, or particular implementations of the computer (1300). Generally, the computer processor (1312) executes instructions and manipulates data to perform the operations of the computer (1300) and any algorithms, methods, functions, processes, flows, and procedures as described in the instant disclosure.

The computer (1300) also includes a memory (1314) that holds data for the computer (1300) or other components (or a combination of both) that may be connected to the network (1302). For example, memory (1314) may be a database storing data consistent with this disclosure. Although illustrated as a single memory (1314) in FIG. 13, two or more memories may be used according to particular needs, desires, or particular implementations of the computer (1300) and the described functionality. While memory (1314) is illustrated as an integral component of the computer (1300), in alternative implementations, memory (1314) may be external to the computer (1300).

In addition to holding data, the memory may be a non-transitory medium storing computer readable instruction capable of execution by the computer processor (1312) and having the functionality for carrying out manipulation of the data including mathematical computations.

The application (1316) is an algorithmic software engine providing functionality according to particular needs, desires, or particular implementations of the computer (1300), particularly with respect to functionality described in this disclosure. For example, application (1316) can serve as one or more components, modules, applications, etc. Further, although illustrated as a single application (1316), the application (1316) may be implemented as multiple applications (1316) on the computer (1300). In addition, although illustrated as integral to the computer (1300), in alternative implementations, the application (1316) may be external to the computer (1300).

There may be any number of computers (1300) associated with, or external to, a computer system containing computer (1300), each computer (1300) communicating over network (1302). Further, the term “client,” “user,” and other appropriate terminology may be used interchangeably as appropriate without departing from the scope of this disclosure. Moreover, this disclosure contemplates that many users may use one computer (1300), or that one user may use multiple computers (1300).

In some embodiments, the computer (1300) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

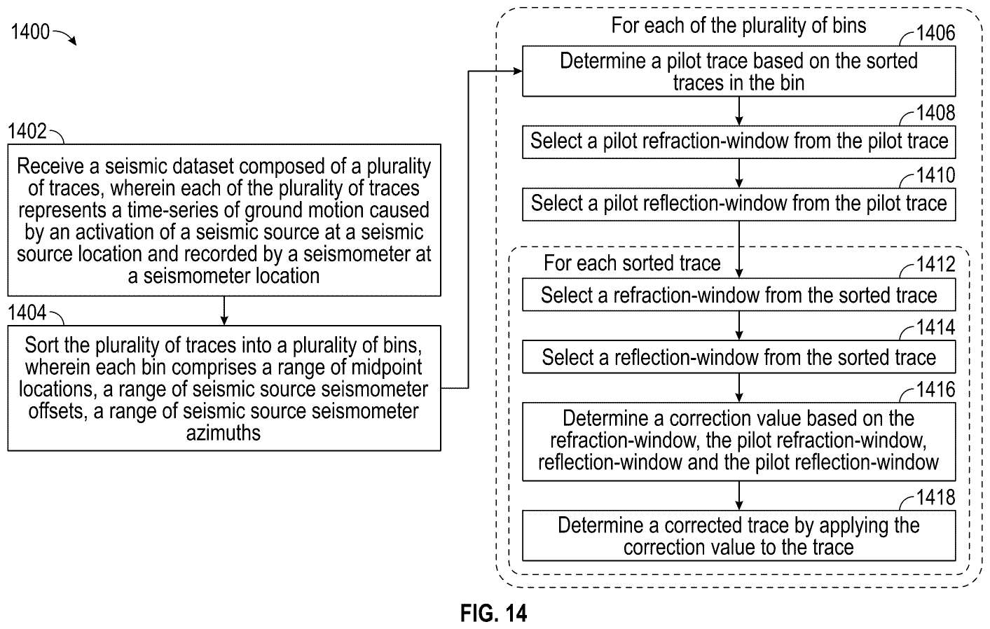

FIG. 14 shows a flowchart (1400) in accordance with one or more embodiments. In accordance with one or more embodiments, in Step (1402) of flowchart (1400), a seismic dataset pertaining to a subterranean region may be received by a seismic processing system. The seismic dataset may be composed of a plurality of traces, with each of the plurality of traces representing a time-series of ground motion caused by an activation of a seismic source at a seismic source location and recorded by a seismometer at a seismometer location. The seismic dataset may be received from a seismic acquisition system that has previously acquired a seismic survey over the subterranean region of interest. The seismic survey may include a four-dimensional survey acquisition geometry including two orthogonal coordinates specifying the seismic source locations and two orthogonal coordinates specifying the seismic receiver locations. The ground motion recorded by the seismic receiver may include one or more components of particle displacement, particle velocity, or particle displacement.

In Step (1404) the plurality of traces making up the seismic dataset may be sorted into a plurality of bins, wherein each bin comprises a range of midpoint locations, a range of seismic source-seismic receiver offsets, a range of seismic source-seismic receiver azimuths. For example, a bin of mid-point locations may include all mid-points within a hundred feet (33 meters) of a specified surface location, a bin of seismic source-seismic receiver offsets may include all offsets between 400 feet and 500 ft, and a bin of seismic source-seismic receiver azimuths may include all azimuths between 0 and 30 degrees East of North. These examples are provided only as illustrative values and are not intended to be limiting in anyway.

In Step (1406), for each of the plurality of bins, a pilot trace may be formed based on the sorted traces in the bin. For example, the pilot trace may be formed, using a brute-stack, or a trimmed-mean stack, or any other stacking method known in the art, without departing from the scope of the disclosed invention.

In Step (1408) a pilot refraction-window may be selected from the pilot trace. The pilot refraction-window may form a time-series of samples of ground motion and enclose some or all of the refracted seismic signals.

In Step (1410) a pilot reflection-window may be selected from the pilot trace. The pilot reflection-window may form a time-series of samples of ground motion and enclose some or all of the reflected seismic signals.

In Step (1412), for each sorted trace within each bin, a refraction-window may be selected from the sorted trace. The refraction-window may commence at the same recording time as the pilot refraction-window commences and terminate at the same recording time as the pilot refraction-window terminates and enclose some or all of the refracted seismic signals forming the trace.

In Step (1414), for each sorted trace within each bin, a reflection-window may be selected from the sorted trace. The reflection-window may commence at the same recording time as the pilot reflection-window commences and terminate at the same recording time as the pilot reflection-window terminates and enclose some or all of the reflected seismic signals forming the trace.

In Step (1416) a correction value based on the refraction-window, the pilot refraction-window, reflection-window and the pilot reflection-window may be determined. Determining the correction value may include determining an interim correction value based on the refraction-window and the pilot refraction-window, determining an interim corrected trace by applying the interim correction value to the sorted trace, selecting an updated reflection-window from the interim corrected trace, determining the correction value based on the updated reflection-window and the pilot reflection-window, and determining the corrected trace by applying the correction value to the interim corrected trace.

Determining the correction value may include determining a similarity between the refraction-window and the pilot refraction-window. For example, the similarity may be a cross-correlation. In some embodiments, the correction value may be a time-shift, while in other examples the correction value may be an amplitude factor.

In Step (1418), for each trace in the bin, a corrected trace may be determined by applying the correction value to each corresponding trace. Further the corrected seismic traces from the plurality of bins may be used to determine a seismic image of the subterranean region. The seismic image may be interpreted, using a seismic interpretation workstation, to determine a location of a hydrocarbon reservoir. Further, a planned wellbore trajectory may be planned, using a wellbore planning system, to penetrate the hydrocarbon reservoir, and a wellbore guided by the planned wellbore trajectory may be drilled, using a drilling system,

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method of correcting a seismic dataset pertaining to a subterranean region, comprising:
receiving a seismic dataset comprising a plurality of traces, wherein each of the plurality of traces represents a time-series of ground motion caused by an activation of a seismic source at a seismic source location and recorded by a seismic receiver at a seismic receiver location;
sorting the plurality of traces into a plurality of bins, wherein each bin comprises a range of midpoint locations, a range of seismic source-seismic receiver offsets, and a range of seismic source-seismic receiver azimuths; and
for each of the plurality of bins:
determining a pilot trace based on a plurality of sorted traces in the bin,
selecting a pilot refraction window from the pilot trace,
selecting a pilot reflection window from the pilot trace, and
for each of the plurality of sorted traces:
selecting a refraction window from the sorted trace;
selecting a reflection window from the sorted trace;
determining a correction value based on the refraction window, the pilot refraction window, reflection window and the pilot reflection window; and
determining a corrected trace by applying the correction value to the trace.

2. The method of claim 1, wherein determining the correction value comprises:
determining an interim correction value based on the refraction window and the pilot refraction window;
determining an interim corrected trace by applying the interim correction value to the sorted trace;
selecting an updated reflection window from the interim corrected trace;
determining the correction value based on the updated reflection window and the pilot reflection window; and
determining the corrected trace by applying the correction value to the interim corrected trace.

3. The method of claim 1, further comprising, using a seismic processing system, determining a seismic image of the subterranean region based, at least in part, on the corrected traces from the plurality of bins.

4. The method of claim 3, further comprising, using a seismic interpretation workstation, determining a location of a hydrocarbon reservoir based, at least in part, on the seismic image.

5. The method of claim 4, further comprising:
planning, using a wellbore planning system, a planned wellbore trajectory to penetrate the hydrocarbon reservoir; and
drilling, using a drilling system, a wellbore guided by the planned wellbore trajectory.

6. The method of claim 1, wherein determining the correction value comprises determining a similarity between the refraction window and the pilot refraction window.

7. The method of claim 6, wherein the similarity comprises a cross-correlation.

8. The method of claim 1, wherein the correction value comprises a time shift.

9. The method of claim 1, wherein the seismic dataset comprises a four-dimensional acquisition geometry recorded using a seismic acquisition system.

10. The method of claim 1, wherein determining the pilot trace comprises forming trimmed-mean stack.

11. A system for correcting a seismic dataset pertaining to a subterranean region, comprising:
a seismic acquisition system configured to acquire a seismic dataset pertaining to the subterranean region; and
a seismic processing system configured to:
receive the seismic dataset from the seismic acquisition system, wherein the seismic dataset comprises a plurality of traces, wherein each of the plurality of traces represents a time-series of ground motion caused by an activation of a seismic source at a seismic source location and recorded by a seismic receiver at a seismic receiver location;
sort the plurality of traces into a plurality of bins, wherein each bin comprises a range of midpoint locations, a range of seismic source-seismic receiver offsets, and a range of seismic source-seismic receiver azimuths; and
for each of the plurality of bins:
determine a pilot trace based on a plurality of sorted traces in the bin,
select a pilot refraction window from the pilot trace,
select a pilot reflection window from the pilot trace, and
for each of the plurality of sorted traces:
select a refraction window from the sorted trace;
select a reflection window from the sorted trace;
determine a correction value based on the refraction window, the pilot refraction window, reflection window and the pilot reflection window; and
determine a corrected trace by applying the correction value to the trace.

12. The system of claim 11, wherein determining the correction value comprises:
determining an interim correction value based on the refraction window and the pilot refraction window;
determining an interim corrected trace by applying the interim correction value to the sorted trace;
selecting an updated reflection window from the interim corrected trace;
determining the correction value based on the updated reflection window and the pilot reflection window; and
determining the corrected trace by applying the correction value to the interim corrected trace.

13. The system of claim 11, wherein the seismic processing system is further configured to determine a seismic image of the subterranean region based, at least in part, on the corrected traces from the plurality of bins.

14. The system of claim 13, further comprising a seismic interpretation workstation configured to determine a location of a hydrocarbon reservoir based, at least in part, on the seismic image.

15. The system of claim 14, further comprising:
a wellbore planning system configured to plan a planned wellbore trajectory to penetrate the hydrocarbon reservoir; and
a drilling system configured to drill a wellbore guided by the planned wellbore trajectory.

16. The system of claim 11, wherein determining the correction value comprises determining a similarity between the refraction-window and the pilot refraction-window.

17. The system of claim 16, wherein the similarity comprises a cross-correlation.

18. The system of claim 11, wherein the correction value comprises a time-shift.

19. The system of claim 11, wherein the seismic dataset comprises a four-dimensional acquisition geometry recorded using a seismic acquisition system.

20. The system of claim 11, wherein determining the pilot trace comprises forming trimmed-mean stack.
